(19) United States
(12) Patent Application Publication
(10) Pub. No.: US 2009/0025536 A1
(43) Pub. Date: Jan. 29, 2009

(54) Method of instruction for musical instruments

(76) Inventor: Philip Chester Dale Olson, Burnsville, MN (US)

Correspondence Address: Philip Chester Dale Olson, 13208 Myrtle Drive, Burnsville, MN, 55337, US

(21) Appl. No.: 11/880,905

(22) Filed: Jul. 25, 2007

(51) Int. Cl. G09B 15/00

(52) U.S. Cl. 84/485 R

(57) ABSTRACT

The present invention is directed toward an instructional methodology that is used in teaching novice or beginner status individuals how to play a musical instrument. The current methodology has been found to be particularly advantageous in teaching the use of stringed instruments such as guitars. More particularly, the instructional system uses a series of repetitive sequencing steps in order for a pupil to understand the positions on the instrument as well as to grasp a fundamental understanding of chord arrangements and musical scales.

### CROSS-REFERENCES TO RELATED APPLICATIONS

None.

### FIELD OF THE INVENTION

The present invention relates to a method for teaching novice, beginning, or even experienced students how to play musical instruments, namely, stringed instruments such as for example a guitar. The method uses interplay of sequencing steps in order to instruct individuals on proper positions on the instrument. Each step forms a specific shape and each shape has a root and an end. Each shape has from one to TEN points of contact with the instrument in some circumstances and the end of a preceding shape is used for form the root of the successive shape.

### BACKGROUND OF THE INVENTION

### Brief Summary of the Invention

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention is a unique instructional methodology that integrates the teaching of chords and notes with numbers (points of contact with the instrument) to create individual positions on the instrument itself In this way, a student can learn to play chord arrangements and/or scales at various positions on the instrument such as on the neck of a guitar, bass, banjo or the like. It should however, be understood that the instant methodology is not so limited to a particular type or category of instrument but can be used to play instrument in different classes or categories.

In one exemplary embodiment of the presently described invention, an instructional methodology for learning to play musical instruments is presented and includes the steps of initially identifying a first position on an instrument and then placing individual fingers at the first position to form a first shape, with the first shape having a root, third and fifth and or an end

Next, the fingers are moved to another position on the instrument, with the second position forming a second shape, which can be similar to the first shape, but is preferably different than the first shape. The second shape, like the first shape is formed with a root, 3^{rd} and a 5th and or an end with the root of the second shape being formed or created from the end of the first shape. That is a portion of the first position, namely the end, is used to form the first position or root of the second position.

Then, the fingers are changed to at least a third position on the instrument in order to develop a third shape. The third shape has a root, 3^{rd} and 5^{th} and or an end with the root of the third shape of the third position being formed from the end of the second shape of the second position.

Additional positions can be created or developed for the instrument, such as along the neck of a guitar. These positions can range for example up to twelve different positions, with each position again having a root (first point of contact) and an end (last point of contact) and forming a shape. Some of the shapes that are formed in each position may be identical to other positions, but need not necessarily be identical to either the preceding or succeeding position on the instrument. However, it should be appreciated that the shapes can be identical throughout the exercise, may vary from one position to the next or may create distinct shape patterns over the twelve or so positions on the instrument.

In a further exemplary embodiment of the presently described invention, a method of teaching for a musical instrument is described and includes the steps of initially establishing a first position on a portion of the musical instrument with the first position having up to TEN points of contact with a portion of the instrument.

Then, a second position is developed on the musical instrument with the second position having up to TEN points of contact with the instrument. The second position is distinct from the first position and the second position includes at least one of the TEN points of contact from the first position.

Next, the individual or student changes to at least a third position on the portion of the musical instrument. The third position again has up to TEN points of contact with the portion of the instrument and the third position is distinct from each of the first and second positions. The third position includes at least one of the TEN points of contact from the second position.

Each of the positions defines a particular shape, which is used in creating a chord or note arrangement. Each position will have up to TEN points of contact with the instrument and each point of contact is assigned a numerical reference as in Music Theory and so as to make for easier structuring of the student's fingers on the instrument.

The student advances through each of the positions on the instrument by using the end of the preceding position to form the root of the succeeding position.

In yet a still further exemplary embodiment of the presently described invention a method of instruction for musical instruments is described and includes the steps of initially forming at least first through third positions on a stringed musical instrument. Each of the first through third positions has from one to TEN points of contact with the instrument and each of the first through third positions has a root, 3^{rd} and a 5^{th} or an end.

Next, one is instructed to advance from the first position to the second position by using the end of the first position to form a root for the second position. Then one moves from the second position to the third position by using the end of the second position to form a root for the first position.

The presently described exemplary embodiment may include the further steps of developing at least fourth through twelfth positions on the instrument, with each of the fourth through twelfth positions having a root, a 3^{rd} and 5^{th} or an end. These successive steps are performed after the step of forming at least first through third positions. Once these additional positions are developed, the student or pupil then instructed to advance through each of the fourth through twelfth positions by using the end of a preceding position to create a root for a succeeding position after the step of developing fourth through twelfth positions. In this way a repetitive mechanism is created to allow a student to easily move through a series of chords or note arrangements in order to learn how to discover chords and scales—and how they are built which in turn teaches the student how to play the musical instrument.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a block diagram showing an exemplary method of practicing the presently described embodiments of the invention; and

FIG. 2 shows a schematic illustration of a portion of a musical instrument used to shows exemplary positions as may be provided in connection with the method of practicing the presently described invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The instant embodiments are directed to an instructional methodology for teaching the playing of musical instruments such as, stringed instruments selected from a group including guitars, bass, banjos and the like. The method uses repetitive sequencing of positional locations to move the student through a series of chord shapes in order to facilitate the learning of the instrument.

The term “position” as used in the present application means the location where the first finger or index finger is placed on the instrument. For example, if you place the index finger on the first fret then the student is in the first position. If the index finger is placed on the fourth fret, the student is then in the fourth position. If the student is in the first position, the index finger on the first fret, the middle finger would be on the second fret, the ring finger on the third fret and the pinky on the fourth fret.

In teaching how to play music students are taught first to play at least three strings on a stringed instrument before learning to play an octave. A simple or basic chord consists of three notes. The details of the notes of a simple cord are labeled the root, the third and the fifth. The last portion of the chord, for purposes of this application is referred to as the end. Each simple chord or more complex chords, once the positional strategy has been determined and the shape of each chord is known from the position, then the student can be encouraged to play the same chord or chords all over the instrument, such as the neck of a stringed instrument.

The present methodology begins by teaching students three simple chords by utilizing three shapes on the strings of the guitar at once. The neck of the guitar then would have four sets of three strings each, since the guitar has six strings that can be broken down into four sets. Set 1 consists of strings 1, 2 and 3 (high E, B and G strings); set 2 consists of strings 2, 3 and 4 (B, G and D strings); set 3 consists of strings 3, 4 and 5 (G, D and A); and set 4 consists of strings 4, 5 and 6 (D, A and Low E strings). This arrangement is then extrapolated and integrated with the “cycle of 4^{th} or 5ths” which associates numbers with letters of notes. An exemplary “cycle” in 5ths is as follows in Table 1:

TABLE 1

| C | D | E | F | G |
|---|---|---|---|---|
| 1 | 2 | 3 | 4 | 5 |
| G | A | B | C | D |
| 1 | 2 | 3 | 4 | 5 |
| D | E | F | G | A |
| 1 | 2 | 3 | 4 | 5 |
| A | B | C | D | E |
| 1 | 2 | 3 | 4 | 5 |

One example of an exercise using the present method is to play three different major chord shapes in Table 1, starting at the 12^{th} fret and work all the way down the neck of the instrument to the 1^{st} fret. Using this cycle of the 5ths the individual can play the first chord at the twelfth fret (the C chord) and then locates the 5^{th} of that chord with the chord shape. The pupil then takes the exact note and uses one of the other two chord shapes available. They then play a new chord shape in which that same note becomes the root of the new chord shape. The student then repeats this process until they reach the first fret. By proceeding in this manner, the student has played thirteen chords over the neck of the guitar.

The pupil, in using this methodology will also have learned three different chord shapes, which can be used to play a variety of chords all over the guitar. This process also teaches the individual where the root and end or fifth are located within these chord shapes. This also allows the student to break down a major scale.

The process can be repeated going up the neck of the guitar, from the first to the twelfth fret. Additional notes can now be added, the third and fourth so that there are additional contact points with the instrument.

In reversing the sequence, thus starting at the first fret, the student plays the “C” chord and then finds the third of the chord shape. Next, the individual finds the fourth contact point of the chord set which is the very next fret or note on the same string as the third point. The pupil then plays the third and fourth in succession. The student then uses the fourth or end of the previous position as the root for the new chord. This pattern is repeated until the pupil reaches the twelfth fret. The student has then played through all of the chords of every major “key” of the instrument.

Additional exercises include the second and then the sixth and the seventh of the chord/scale shape. At the conclusion of these exercises the individual will not only know a good portion of the neck of the instrument but also provides a foundation for understanding more complex music theory. That is, they are able to not only read notes, but also apply the positions to the instrument by playing the chords and scales that surrounds the chords.

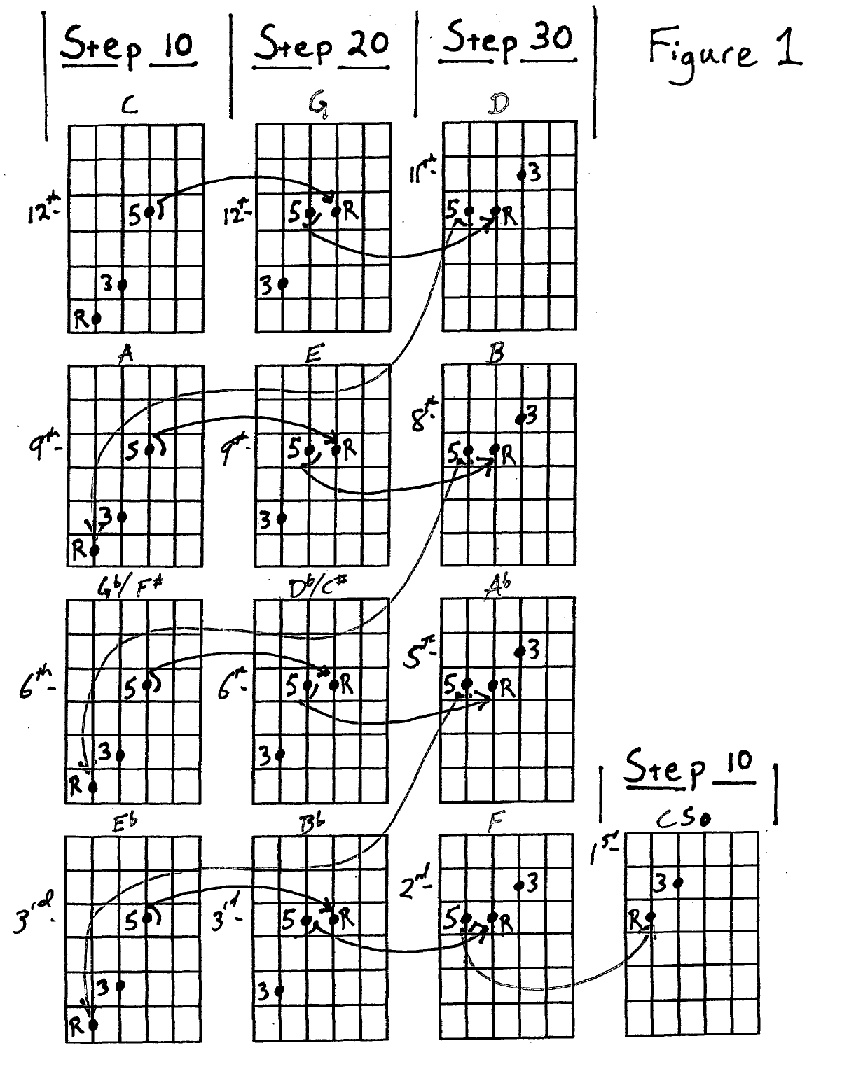

Now turning to FIG. 1, which shows a block diagram generally illustrating the steps of the methodology used in carrying out the present invention. The process begins and at step 10 the first through third positions are developed and the individual sets up by applying fingers to one or more strings on the instrument. Each of the positions or chords will have a shape. The shapes can be the same, practicing the same chord on different portions of the neck of the instrument or alternatively, different shapes where different chords are played at different portions of the instrument or on the same portion of the neck of the instrument.

Next, the student moves from the first to the second position by using the end or final portion of the chord shape as the root portion of the second position or second chord shape at step 20. This process is then repeated as the individual moves from the second position or chord shape to the third position or chord shape by using the end or 5^{th} in the cycle of the second chord shape to create the root of the third position or third chord shape. This process can be repeated at step 30 through the 12^{th} fret and creating thirteen chord shapes or positions, which can be identical or different or create distinct patterns of chord shapes.

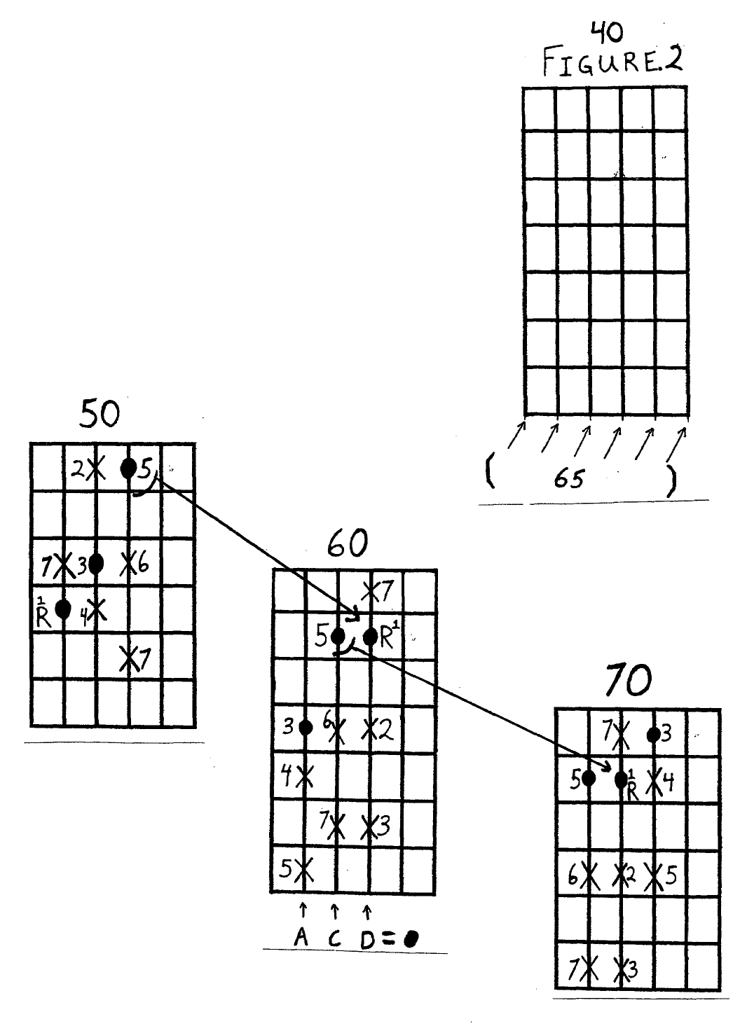

Reference is now directed to FIG. 2 of the presently described embodiment which shows a section of a neck of a stringed instrument 40. Exemplary chord or position shapes are shown at reference numerals 50, 60, and 70 and the TEN points of contact in position 50 are illustrated by numerals Root/1-7. Three points of contact in position 60 are represented by alpha characters A, C and D. The strings of the instrument are designated by reference numeral 65 (although only three lead lines are used for the purposes of this illustration, it should be understood that additional strings are present or that the instrument can have more or less strings than those provided.

The present invention may also be utilized to teach music students how to play notes at the same pitch and then repeat the notes on different areas on the neck of the instrument. For example, the notes of E, F and G that are on the music staff are located at the top space, top line and above the top line. The same notes, or groups of notes if different sequences are selected can be played at different positions on the instrument. Keep in mind that a “position” is four frets and each finger is dedicated to a fret. The following table may be useful in further clarifying this embodiment of the invention.

Table 2 is illustrative of the notes E, F and G all being played n a single string using the following strings/positions.

| | |
|---|---|
| First String | First Position |
| Second String | Fifth Position |
| Third String | Ninth Position |
| Fourth String | Fourteen Position |
| Fifth String | Nineteenth Position |

Table 3 is exemplary of three notes E, F and G being played on two strings.

| | |
|---|---|
| First and Second Strings | Third Position |
| Third and Fourth Strings | Twelfth Position |
| Fourth and Fifth Strings | Seventeenth Position |

In the present embodiment, there are also two unique positions that do not repeat anywhere else on the instrument they are illustrated in Table 4. The three notes are again E, F and G and are selected for illustrative purposes only.

TABLE 4

| | |
|---|---|
| Second and Third Strings | Eighth Position |
| Third and Fourth Strings | Sixth Position |

The foregoing represents just one example of the myriad of ways to view playing notes with repetition on the neck to facilitate learning the instrument and expediting the users grasp of the methodology of playing music such that after a student learns to play a full octave of notes they can then easily progress into chords and more complex arrangements.

It will thus be seen according to the present invention a highly advantageous method of teaching the playing musical instruments has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. An instructional methodology for learning to play musical instruments, comprising the steps of;
identifying a first position on an instrument;
placing individual fingers at said first position to form a first shape, said first shape having a root and an end;
moving to a second position on said instrument, said second position forming a second shape, with a root and an end, said root of said second shape of said second position formed from said end of said first shape at said first position; and
changing to at least a third position on said instrument and developing a third shape, said third shape having a root and an end with said root of said third shape of said third position formed from said end of said second shape of said second position.

2. An instructional methodology as recited in claim 1, wherein said first and second shapes are distinct from one another.

3. An instructional methodology as recited in claim 1, wherein said first, second and third shapes are distinct from one another.

4. An instructional methodology as recited in claim 1, wherein said instrument is a stringed instrument.

5. An instructional methodology as recited in claim 4, wherein said stringed instrument is a guitar.

6. An instructional methodology as recited in claim 1, wherein each of said first, second and third shapes has up to ten points of contact with said instrument.

7. An instructional methodology as recited in claim 1, wherein at least one of said first, second and third shapes is a chord arrangement.

8. An instructional methodology as recited in claim 1, wherein each of said first, second and third shapes is a chord arrangement.

9. An instructional methodology as recited in claim 1, wherein said root can be used to identify a scale.

10. An instructional methodology as recited in claim 1, including a further step of creating a fourth position on an instrument and developing a fourth shape which is similar to one of said first, second and third shapes.

11. A method of teaching for a musical instrument, comprising the steps of;
establishing a first position on a portion of said musical instrument, said first position having up to ten points of contact with said portion of said instrument;
developing a second position on said portion of said musical instrument, said second position having up to ten points of contact with said portion of said instrument and said second position being distinct from said first position, said second position including at least one of said ten points of contact from said first position; and
changing to at least third position on said portion of said musical instrument, said third position having up to ten points of contact with said portion of said instrument and said third position being distinct from each of said first and second positions, said third position including at least one of said ten points of contact from said second position.

12. A method of teaching for a musical instrument as recited in claim 11, including further steps of developing positions four through twelve on said portion of said instrument with each of said fourth through twelfth positions being distinct from one another.

13. A method of teaching for a musical instrument as recited in claim 11, wherein said instrument is a stringed instrument and said portion of said instrument is a neck.

14. A method of teaching for a musical instrument as recited in claim 13, wherein said stringed instrument is selected from a group including guitar, bass and banjo.

15. A method of teaching for a musical instrument as recited in claim 11, wherein each of said first, second and third positions create shapes that are distinct from one another.

16. A method of teaching for a musical instrument as recited in claim 15, wherein each of said first, second and third positions have a root and an end.

17. A method of teaching for a musical instrument as recited in claim 16, wherein said end of said first position is the root for said second position and said end of said second position is the root for said third position.

18. A method of instruction for musical instruments, comprising the steps of,
forming at least first through third positions on a stringed musical instrument, with each of said positions having from one to ten points of contact with said instrument and each of said first through third positions having a root and an end;
advancing from said first position to said second position by using said end of said first position to form a root for said second position;
moving from said second position to said third position by using said end of said second position to form a root for said first position.

19. A method of instruction for musical instruments as recited in claim 18, including further steps of developing at least fourth through twelfth positions on said instrument, with each of said fourth through twelfth positions having a root and an end, after the step of forming at least first through third positions.

20. A method of instruction for musical instruments as recited in claim 19, including further steps of advancing through each of said fourth through twelfth positions by using the end of a preceding position to create a root for a succeeding position after the step of developing fourth through twelfth positions.
